(19) United States
(12) Patent Application Publication
(10) Pub. No.: US 2016/0275822 A1
(43) Pub. Date: Sep. 22, 2016

(54) KIT OF INFORMATION MEDIA

(71) Applicant: TIME TO MARKET S.R.L., Roma (IT)

(72) Inventors: Alessandro LUZZI, Rome (IT); Roberto FIUMARA, Rome (IT)

(73) Assignee: TIME TO MARKET S.R.L., Rome (IT)

(21) Appl. No.: 15/034,309

(22) PCT Filed: Nov. 5, 2014
(86) PCT No.: PCT/EP2014/073846

§ 371 Date: May 4, 2016

(30) Foreign Application Priority Data
Nov. 8, 2013 (IT) RM2013A000617

(51) Int. Cl. G09F 1/10; A47F 5/08; G09F 15/00

(52) U.S. Cl. CPC G09F 1/10; G09F 15/0068; A47F 5/08

(57) ABSTRACT

Kit (1) of information media, comprising at least one module (2); at least one rigid pocket (3) adapted to contain objects such as postcards, lottery tickets, and the like; at least one hinge (4) adapted to allow the joining of consecutive modules (2); at least one clip (5) adapted to support one or more articles such as postcards, tickets, posters and the like, said clip (5) being applicable by means of reversible interlocking, along the edges of the module(s) (2); at least one fastener (6) adapted to fasten said module (2), or set of modules (2) previously assembled together, on the walls of a room or on the edges of a common rigid panel, said kit (1) being characterized in that the module(s) (2), having a profile defined by any closed curve or polygonal form, has grooved cylindrical projections along the edges thereof; the longitudinal axis of said projections being parallel to the edge from which said projections are extended, said projections being spaced by grooves, said grooves being longitudinally crossed by rigid and cylindrical segments firmly connected to said cylindrical projections, said segments and said grooves defining, for each groove, a cavity.

### FIELD OF THE ART

The present invention refers to the field of communication systems, typically of images, for the transmission of information. More in detail the present invention refers to a kit of information media adapted to render more visible, for the clientele of stores such as tobacconists, information pertaining to the sales of specific articles, as well as to inform the clientele of the services offered inside said stores.

### STATE OF THE ART

Widely known and widespread in most countries of the world are stores where the sale of state monopoly products is allowed, as well as the sale of many other articles. Inside these stores, commonly known as tobacconists, it is in fact possible to purchase many different products such as tobacco, revenue stamps, telephone cards, stationary articles, hygiene articles and many more items.

Recently, tobacconists have also offered citizens the opportunity to make use of services pertaining to the payment of utility bills and fines. In addition, due to the computer network of lottery and betting operators, tobacconists are currently also used as betting agencies.

In the future, other services will also be added, thus transforming the tobacconists, and generally all authorized retail points, into actual service centers of public utility. For such purpose, it should be considered that tobacconists are almost always small-size stores, which undoubtedly is in contrast both with the current number and with the increasing number of services offered by this type of store. Up to now, tobacconists, and more generally all places where it is possible to purchase articles of varied type and make use of the abovementioned services, are in fact among the most crowded public stores, decidedly more chaotic relative both to the arrangement of the articles being sold and to the arrangement of the offered services, for which there are almost always lines of people waiting to purchase products and/or request a specific service. In order to render the arrangement of the products more ordered and harmonious, and above all more functional, the arrangement of the products, the managers of the stores in question often make use of dispensers adapted to contain and group together the same articles, such as, by way of a non-limiting example, pencils, postcards, lottery tickets etc. Normally these are optically transparent plastic containers, shaped as rigid pockets containing a specific quantity of a determinate article. However, even if these containers are undoubtedly useful, tobacconists remain today places where the visual impact for the clientele corresponds with a disordered setting, in which it is difficult to easily identify the object of interest, and understand, without having to ask the store manager, if it is possible to make use of a specific service or no.

For such purpose, the present industrial invention patent application, described in detail hereinbelow, proposes a new and original type of information media adapted to “lighten” the distribution and arrangement of the objects inside the premises in question, and at the same time facilitate the clientele in identifying the product and/or the actual existence of the service of interest to be requested.

### DESCRIPTION OF THE INVENTION

The present industrial invention patent application describes a new and innovative type of information media adapted to allow the clientele of stores such as, by way of a non-limiting example, tobacconists and the like, to easily identify the type of products and services offered inside the premises where said media are placed, and at the same time also group together, in an ordered manner, a certain quantity of the same products. More in detail, the present invention refers to a kit of information media, consisting of modules variously assembled together, giving rise to structures of various size and shape and adaptable to the size of any premises. More specifically, these are polyhedral structures, preferably entirely hollow cubic and/or parallelepiped structures that can be combined together in various ways. Still more in detail, each of the listed geometric structures can be obtained by the assembly of modules with profile, preferably but not exclusively, that is square and/or rectangular and/or triangular, which can be assembled together in various ways.

The joining of the single modules occurs due to the particular profile that can be found on the edges of each module and due to the hooking systems that allow the joining of consecutive modules. Said profile and said hooking systems have been specially designed and obtained in order to allow the easy ad reversible joining of the single modules, so as to be able to give rise to the aforesaid flat and/or polyhedral structures. Each module, independent of its geometric profile, comprises a rigid medium on which an optically transparent protective screen is optionally placed. By way of a non-limiting example, said screen is a common PMMA layer, for example a layer of material commercially known as plexiglass. More clearly, each module is structured to be used as a common photograph—carrier. Any one information sheet is in fact placed between said medium and said optional layer of optically transparent material, as it is desired to enhance the visibility of such sheet. As mentioned, the assembly of the single modules for forming the polyhedral container structures occurs due to the particular profile that can be found on the edges of each module, more in detail on the edges of the rigid medium, and also due to hooking systems, indicated hereinbelow as hinges, that can be adapted/fit on said edges. Overall, this allows the joining of consecutive modules. Each module of the present kit has cylindrical projections along the edges thereof which are extended along the entire perimeter of the module. Said cylindrical projections have their longitudinal axis extended parallel to the edge to which they are integral, and they are spaced by grooves. Overall, a profile similar to that of a toothing is defined on the edges of each module. In the space defined by the grooves situated between the aforesaid cylindrical projections, rigid segments can also be observed, these also cylindrical.

As will be clearer in the course of the present description, and from the observation of the enclosed drawings, the profile that can be found on the edges of each module of the present kit allows offering effective fastening zones for hooking systems, comprised in the kit, i.e. for hinges which, once applied by means of interlocking along the edges of the modules, will allow connecting together consecutive modules. In addition to said hinges, the kit of information media also comprises other components. In particular, the kit comprises rigid pockets, to be applied on the front surface of the modules, adapted to contain objects of varied type such as lottery tickets, postcards, advertizing posters, etc.; and clips to be fixed along the edges of one or more modules, adapted to support typically paper products such as postcards and the like. As already mentioned, the present kit of information media was obtained in order to optimize the distribution of some products sold, typically but not exclusively, inside stores such as tobacconists. Said kit allows obtaining information media structures which in addition to supporting the product of interest, also render product(s) itself more visible and/or accessible to the clientele, thus informing it in a more direct manner with regard to the type, and/or actual existence, of the services offered inside the structure. The kit in fact comprises further versatile components that have characteristics such to allow the fastening of single modules, or modules assembled together in various ways, on surfaces such as the faces of a wall or on the edges, with varied thickness, of structures of varied type, preferably on the edges of structures such as, for example, the panels which generally are found inside the betting agencies, in order to separate the clientele from the manager of the service as well as to move the clientele away from the machines actuating said service.

### BRIEF DESCRIPTION OF THE DRAWINGS

FIG. 1 shows a perspective view of the components of the kit 1 of information media, object of the present industrial invention patent application. More in detail, the figure in question shows that said kit 1 comprises: at least one module 2 adapted to support on its surface any one information sheet possibly covered with a layer of PMMA (not shown in the figure in question); at least one hinge 4 adapted to assemble one module 2 to another module 2; at least one pocket 3, to be assembled at the surface of a module 2 due to at least two hinges 4, and adapted to support articles such as postcards, tickets and the like; at least one clip 5 to be applied at the edges of the module 2 and adapted to support one or more articles of the following type: sequences of tickets, postcards and the like; and at least one fastener 6 which, due to its components, described in detail in the following figures, allows fixing a module 2 or a set of modules 2 previously assembled together on a wall or on the edges of a panel of varied thickness.

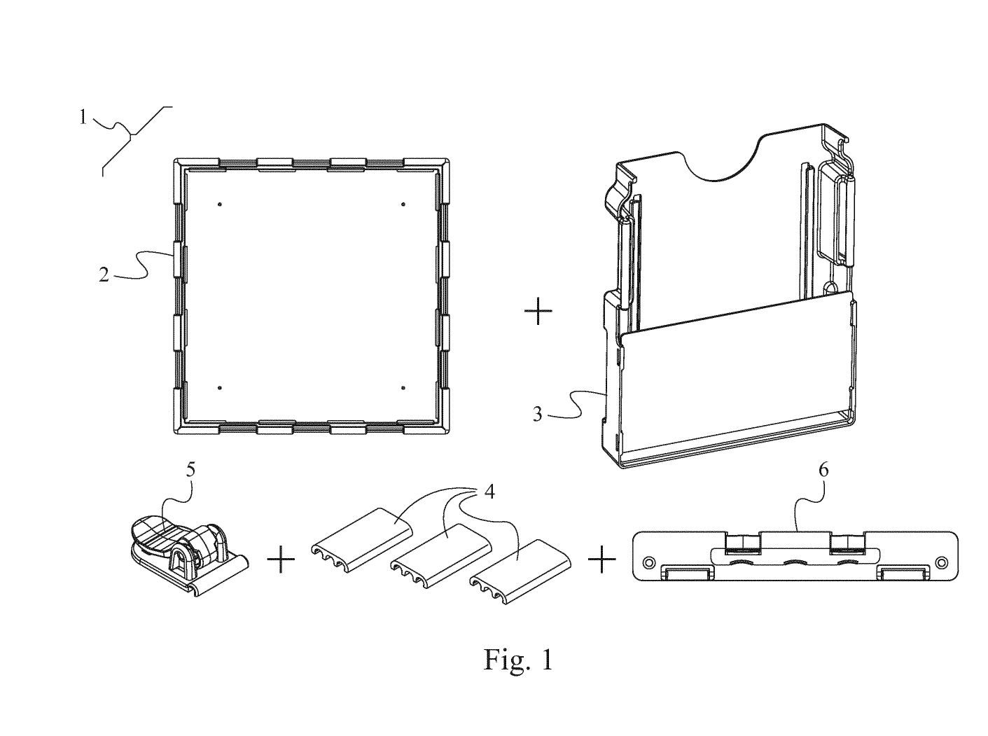

FIG. 2 shows a detailed view of a module 2 comprised in the present kit 1 of information media. More in detail, the figure in question shows that said module 2—which in the figure in question has a square form but which can have a profile defined by any closed curve or polygonal form—has, on its edges, cylindrical projections 7 grooved in longitudinal sense and spaced by grooves 8. A toothing-like edge is thus defined overall. Along each of the grooves 8 present along the edges of the module, are observable that travel through the entire groove and are firmly connected to the cylindrical projections 7. Said segments 9 and the grooves 8 are shaped and sized in a manner such to constitute an effective hooking system for the hinges 4 (not shown in the figures). More in detail the grooves 8 and the segments 9 define the air space 10 which allows the insertion and interlocking, for each groove 8, of a hinge 4. Said hinge, not shown in the figure in question, allows the connection of one module 2 to another module 2. Overall this allows obtaining three-dimensional structures with various shapes, preferably with polyhedral geometry.

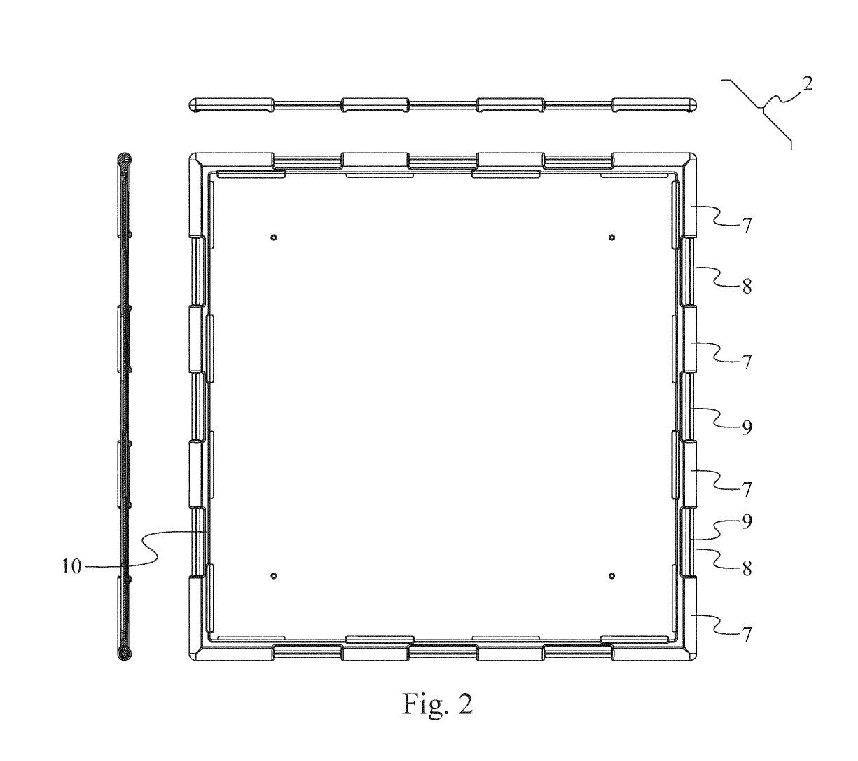

FIG. 3 shows a detailed view of the hinge 4 comprised in the kit 1 of information media. The figure shows that said hinge 4 has a rectangular profile and has, on one of its surfaces, at least two grooves 11 suitable for being fit by means of interlocking with the segments 9 present along the edges of modules 2. The assembly allows connecting one module 2 to another module 2, also allowing the 360° rotation of the two connected modules 2, with respect to said hinge 4.

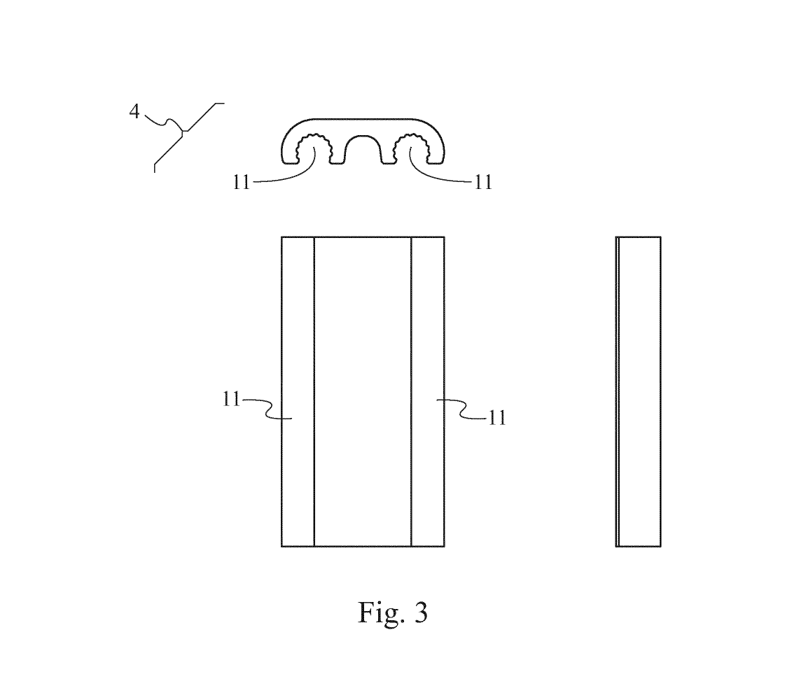

FIG. 4 shows a detailed view of a further component of the kit 1. More in detail, the figure in question shows a detailed view of a pocket 3 comprised in the kit 1, adapted to contain a plurality of articles such as postcards, tickets, cards or stationary articles such as pens, erasers, pencils and the like. Said pocket can be found on the surface of a module 2 and is connected to the latter due to the aforesaid hinges 4. More in detail, each pocket 3 comprised in the kit 1 comprises: the front surface 3′ to be directed towards the viewers, the rear surface 3″ to be directed towards the surface of the module 2 on which said pocket 3 is placed, and the side surfaces 3′″ having finishing that allow the fastening of the hinges 4 as well as the indirect connection of the pocket 3 to the edges of the module 2. More in detail each side surface 3′″ has a convexity 17, by which the groove 12 having the segment 13 is defined. Overall, a hooking system is defined that is similar to that which can be found on the edges of the module 2 at the grooves 8. Said segments 13 can in fact be fit, by means of interlocking, with the grooves 11 of the hinges 4 (not shown in the figure in question). Once a groove 11 of the hinge 4 is assembled with a groove 12, it is possible to connect the remaining groove 11 with the groove 8 of the module 2, thus determining the assembly of the pocket 3 to the module 2. As is observed in the figure in question, the pocket 3 also has other particular characteristics, such as the recess 16 that can be found along the upper edge of the front surface 3′. Said recess has aesthetic value.

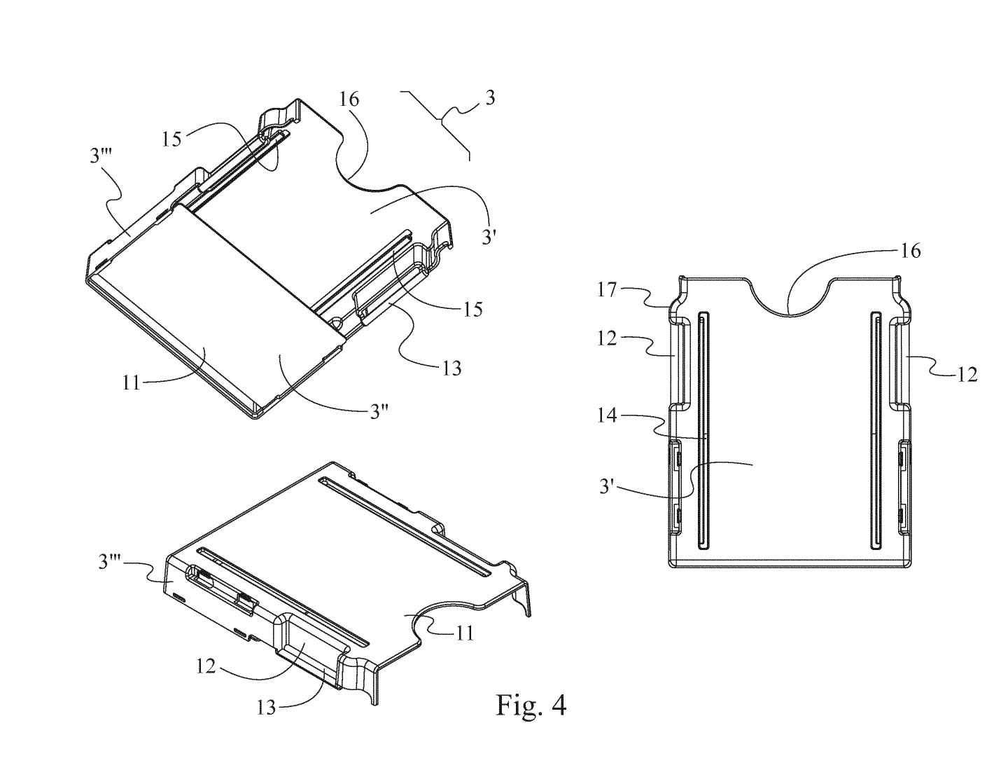

FIG. 5 shows a detailed view of a further component comprised in the kit 1 of information media, i.e. of a clip 5. More in detail, said clip 5 comprises the U-shaped base 18 from which the parallel projections 19, joined by a pin 20, depart orthogonally; with respect to said pin, a tab 21 is free to carry out a 180° rotation. On the linear edge 22 of said base 18, the grooved projection 23 can be found, whose groove 24 is adapted to the size of the segments 9, thus allowing the connection of the clip 5 to the module 2, as well as that of the articles fixed to the clip 5.

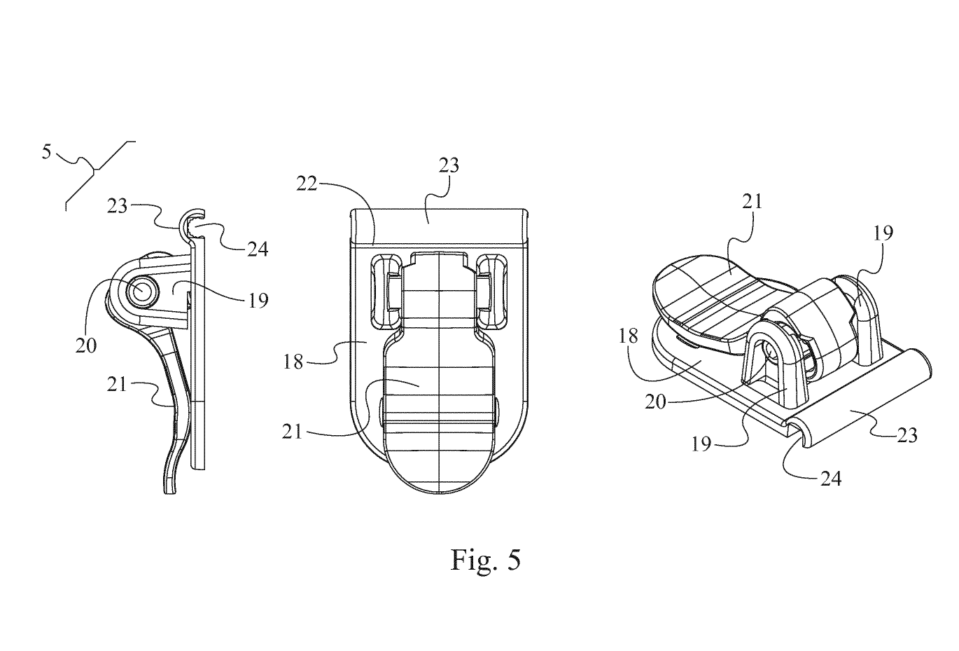

FIG. 6 shows a detailed view of a further component comprised in the present kit 1. More in detail the figure in question shows a detailed view of the fastener 6 adapted to fasten one or more modules 2 previously assembled together on a surface, such as the wall of a room or the edges of a panel of varied thickness. Said fastener 6 has a rectangular profile and has, on its surface, at least two grooved and cylindrical projections 25, having the grooves 26, to be fit at the edges of the modules 2; at least two holes 27 adapted to allow fixing, by means of screws or hooks or similar systems, the fastener 6 as well as the module(s) 2 on a wall; at least one recess 29, preferably at least two recesses 29, can be found on one of its two longer sides 28, adapted to generate holes 30 of variable width due to mating systems 31 slidable inside said recesses 29. The slidable systems 31 have projections 31′, orthogonal to the surface of the fastener 6, on which it is possible to manually operate in order to adjust the width of the holes 30. Tabs 32 can also be found on the fastener 6, in the specific case of the figure in question three tabs 32 adapted to generate a grip of variable width, in order to allow the assembly and the fastening of said fastener 6 to the edge, of variable thickness, of a common rigid panel.

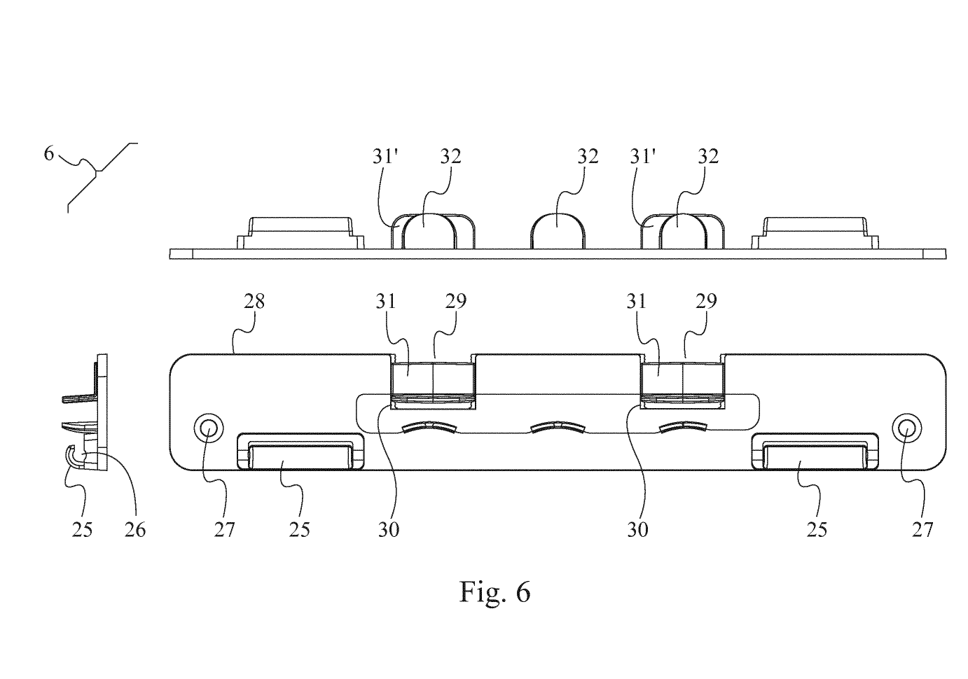

FIG. 7 shows a detailed view of a module 2 embodiment in which said module 2 has a different profile from the square profile observed in the preceding figures. In the figure in question, the profile of the module 2 is defined by a closed curve.

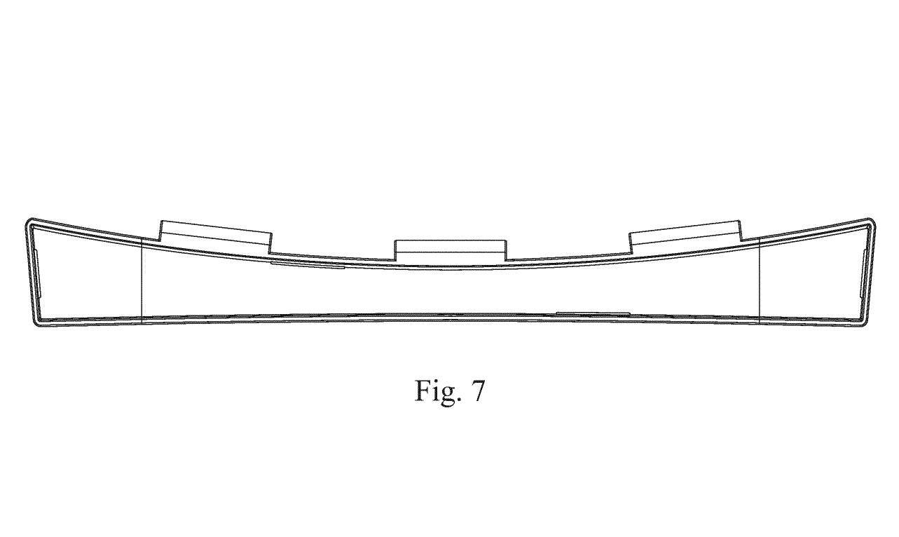

### DESCRIPTION OF THE PREFERRED EMBODIMENTS

In all embodiments thereof, the kit 1 of information media, object of the present industrial invention patent application comprises: at least one module 2, preferably a plurality of modules 2 adapted to support one or more advertizing sheets on their surface; at least one pocket 3, typically a plurality of pockets 3, to be applied on the front surface of one or more modules 2 and adapted to contain objects such as postcards, lottery tickets and the like; at least one hinge 4 to be applied, by means of interlocking, along the edges of the modules 2, in a manner so as to allow the connection of one module 2 to another module 2; at least one clip 5, preferably a plurality of clips 5, to be applied by means of interlocking along the edges of the module(s) 2 and adapted to support one or more articles such as postcards, tickets, posters and the like; and at least one fastener 6 adapted to fasten one or more modules 2, variously assembled together, to surfaces such as the walls of a room or to structures such as rigid panels of varied thickness. In some embodiments, said modules 2 have holes on their surface, preferably at least two holes adapted to allow the insertion of screws or hooks, for direct fastening of said modules 2 on a wall.

More in detail, the components of the kit 1 of information media, object of the present description, are obtained as follows:

first of all, each module 2 has a profile defined by any closed curve or polygonal form. Preferably, each module 2 has a square, rectangular or triangular profile, in a manner such to obtain structures with polyhedral geometry, by assembling the various modules together. Cylindrical projections 7 integral with the edges can be observed along the edges of each module 2; projections and edges are made of the same material. Said cylindrical projections 7 are spatially configured in a manner such to have their longitudinal axis extended parallel to that of the edge from which they are extended. Said projections 7 are also optionally internally hollow and spaced by grooves 8 in a manner such to define a toothing-like profile along the edges of said modules 2. At the space delimited by the grooves 8, cylindrical segments 9 of a rigid rod can be observed; said segments cross the grooves 8, and are firmly connected to the cylindrical projections 7. The size of the cylindrical segment 9 and that of the grooves 8 are such to define, for each groove 8, the air space 10. Said air space 10 and the segment 9, which can be found for each groove 8, define a support system such to allow the fastening, by means of interlocking, of the hinge 4, adapted to connect together two consecutive modules 2.

Said hinge 4 is in fact made of a rigid material, has a rectangular profile and has two longitudinal and parallel grooves 11 whose radius of curvature allows the adaptation and fastening, by means of interlocking, of the hinge 4 to the edges of two consecutive modules 2. More in detail, said interlocking involves the grooves 11 of the hinge 4 and the segments 9. The connection between the two consecutive modules 2 ensures the 360° rotation thereof, with respect to the hinge 4 that connects them, thus contributing to the attainment of three-dimensional structures with the most disparate profiles.

The hinges 4 also allow the assembly of the pockets 3 to the modules 2. Each pocket 3 has a rigid box-like shape and is preferably made of an optically transparent, rigid plastic material. More in detail, each pocket 3, when applied on the surface of the module 2, has: the front surface 3′ to be directed towards the viewers; the rear surface 3″, of smaller extension than that of the surface 3′, to be directed towards the surface of the module 2, and the side surfaces 3′″ placed close to the edges of the module 2. Still more in detail, the assembly of the pocket 3 to the module 2 occurs due to the particular structure of the side surfaces 3′″ of the pocket 3. Said surfaces 3′″ in fact have the groove 12 in which the segment 13 can be found. Overall, a system is obtained that is analogous to that defined by the aforesaid grooves 8 and segments 9. This allows the adaptation and indirect interlocking of the pocket 3, at the edges of the module 2, due to the hinges 4. The adaptation of one of the grooves 11 of the hinge 4 to the segment 9 and the adaptation of the other groove 11 to the segment 13 of the pocket 3 will in fact allow the stable assembly of the pocket 3 to the module 2. The pockets 3 comprised in the present kit 1 also have characteristics that render them particular from both the aesthetic and functional standpoint: in particular, the surface 3′ of the pocket has two longitudinal cavities 14 from which longitudinal projections 15 depart, inside the pocket, said projections adapted to ensure the precise insertion and stabilization of the object(s) placed inside the pocket. Typically, said objects are postcards, tickets with normally rectangular format, cards and the like. The rear surface 3″ of the pocket 3 is instead characterized in that in addition to having a smaller extension than that of the surface 3′, it is also removable. Said surfaces are also preferably made of PMMA or any other preferably optically transparent polymeric material. The pocket 3 also has other characteristics which contribute to making it unique, such as the semicircular recess 16 that can be found on the upper edge of the surface 3′ and the lateral convexities 17 from which the grooves 12 are defined.

As already mentioned, the kit 1 of information media, object of the present description, comprises further components adapted to enhance the functionality and efficiency of the object of the invention. Said kit more specifically comprises at least one clip 5 and at least one fastener 6, preferably a plurality of clips 5 and a plurality of fasteners 6.

The clips 5 of the present kit 1 have the U-shaped base 18, two projections 19 parallel to each other that are extended orthogonally to the base 18, a pin 20 joining said projections 19 with respect to which a rigid tab 21 can rotate 180°. Said tab 21, with a common reversible interlocking mechanism, can be locked on the surface of the base 18, thus also allowing an article such as a card, sheet and the like to be fastened on said surface. Said articles are in fact retained between the surface of the U-shaped base 18 and said rigid tab 21. The clip(s) 5 comprised in the kit 1 can also be assembled at the edges of the module 2 due to systems similar to those that allow the assembly between consecutive modules 2, and between the pockets 3 and the modules 2. More in detail each clip 5 has, on the linear edge 22 of the base 18, a profile that fits well with that of the segments 9 of the modules 2. Still more in detail, on said linear edge 22, the grooved projection 23 can be found whose groove 24 is adapted to the size of the segments 9, thus allowing the connection of the clip 5 to the module 2, as well as the indirect connection of the articles fastened to the clip 5.

A further component comprised in the kit 1 is the fastener 6. Said fastener 6 allows fastening a module 2, or a set of modules 2 previously connected together, on a support such as, by way of a non-limiting example, the face of a wall or the edges of a rigid panel like those that are situated inside the tobacconists/betting agencies and which are adapted to separate the clientele from the manager of a service. The fastener 6 has a rectangular profile and has, on one of its surfaces, at least two cylindrical projections 25 with the same profile as the projections 7 of the modules 2 and adapted to allow the connection of the module 2, or of a set of modules 2 previously assembled together, to said fastener 6. Said projections 25 are in fact grooved and each has a groove 26, that can be adapted by means of interlocking with the segments 9. The fastener 6 also has at least two holes 27, one placed in proximity of a shorter side of the rectangle, the other in proximity of the opposite side. Said holes 27 are adapted to allow the passage of screws or hooks for fastening on a wall. The fastener 6 has, along the edge of one of the longer sides 28 of its rectangular profile, at least one recess 29, preferably at least 2 recesses 29 that generate holes 30, of variable width, due to mating systems 31 slidable inside the recess. Said slidable systems 31 are represented by portions of the same material constituting the fastener 6 and each have projections 31′ directed orthogonally to the surface of the fastener 6, on which it is possible to manually operate in order to adjust the width of the holes 30. At the front of said systems 31′, projecting tabs 32 can also be found, preferably three tabs 32, also directed orthogonally to the rectangular plane of the fastener 6. These components, i.e. the slidable systems 31 and the tabs 32, allow obtaining a grip, of variable width, for the edge of a common rigid panel. Overall, this also allows adapting the kit 1 on media such as, by way of a non-limiting example, the separator panels usually found inside the tobacconists, which serve to define a barrier between the manager of a service and the clientele. The assembly of one or more modules 2 of the kit 1 to said panel is therefore useful for showing viewers the type of services offered inside the structure.

In all embodiments thereof, the present kit 1 comprises: the modules 2 having the sides with a length comprised between 10 cm and 40 cm, preferably between 15 cm and 30 cm, still more preferably of the modules 2 with lengths of the sides 15×30 or 15×15 or 30×30 and with thicknesses comprised between 4 mm and 12 mm, preferably 8 mm; the pockets 3 having front surface 3′ with a width comprised between 10 cm and 15 cm, preferably 12.4 cm and a height comprised between 12 cm and 18 cm, preferably 14.9 cm, the rear surface 3″ having a width comprised between 10 cm and 15 cm, preferably 12.4 cm and a height comprised between 9 cm and 12 cm, preferably 10.5 cm, and the side surfaces 3′″ having a width comprised between 15 mm and 25 mm, preferably 23.01 mm and a height comprised between 12 cm and 18 cm, preferably 14.9 cm; the hinges 4, with rectangular profile, having the sides with a length comprised between 1.60 cm and 4.0 cm, preferably the shorter sides 2.045 cm and the longer sides 3.90 cm, and a thickness comprised between 4 mm and 8 mm, preferably 5.60 mm; the clips 5 having a width comprised between 20 mm and 40 mm, preferably 39.41 mm, a height comprised between 55 mm and 70 mm, preferably 63.03 mm, and a thickness, measured taking into account the height of the projection 19, comprised between 18 mm and 25 mm, preferably 21.96 mm; the fastener 6 having the sides with lengths comprised between 3 cm and 30 cm, preferably the shorter sides having length of 3.625 cm and the longer sides having a length of 24.149 cm. The thickness of the fastener 6, calculated taking into account the height of the tabs 32, is comprised between 10 mm and 18 mm and preferably is 18 mm. In all embodiments thereof, the components of the kit 1 are made of polymeric material, preferably made of PC and/or PMMA.

1. Kit of information media, comprising at least one module, adapted to support one or more advertising sheets on its surface, having at least two holes for the passage of screws, hooks and the like; at least one rigid pocket adapted to contain objects such as postcards, lottery tickets and the like, said rigid pocket being applicable on the surface of said module(s); at least one hinge adapted to allow the joining of consecutive modules, said hinge(s) being applicable, by means of reversible interlocking, along the edges of the module(s); at least one clip adapted to support one or more articles such as postcards, tickets, posters and the like, said clip being applicable, by means of reversible interlocking, along the edges of the module(s); at least one fastener adapted to fasten said module, or set of modules previously assembled together, on the walls of a room or on the edges of a common rigid panel, said fastener being applicable along the edges of the module, said kit being wherein the module(s), having a profile defined by any closed curve or polygonal form, has grooved cylindrical projections along the edges thereof; the longitudinal axis of said projections being parallel to the edge from which said projections are extended, said projections being spaced by grooves, said grooves being longitudinally crossed by rigid and cylindrical segments firmly connected to said cylindrical projections, said segments and said grooves defining, for each groove, the air space.

2. The Kit of information media, according to claim 1, wherein the hinge(s) has a rectangular profile and has, in its thickness, at least two longitudinal grooves that are parallel to each other, said grooves having a radius of curvature that can be adapted to the size of said rigid cylindrical segments, said hinge, when assembled to the segments of two modules joined by said hinge(s), allowing the 360° rotation of said modules with respect to said hinge(s).

3. The kit of information media according to the preceding claim 1 wherein the pocket(s), of rigid box-like shape, has, when said pocket is applied on the surface of the module, its front surface to be directed towards the viewers, the rear surface, of smaller extension than that of the front surface, to be directed towards the surface of the module, and the side surfaces connected to the edges of the surface of the module on which said pocket is placed, said side surfaces each having at least one groove in which the segment, similar to the segment of module, can be found; said segment being adaptable to the groove of the hinge(s), the latter indirectly connecting said pocket to the edges of the module.

4. The kit of information media, according to claim 1, wherein the clip(s) comprised in said kit has a U-shaped base; at least two projections parallel to each other and extended orthogonally to said base; the pin joining said projections; the tab, said tab being free to rotate 180° with respect to said pin and being lockable, with a common reversible interlocking mechanism, on the surface of said base, the latter having the grooved projection on its linear edge, said projection having the groove, the latter being adaptable to said segments by means of reversible interlocking.

5. The kit of information media according to claim 1, wherein the fastener has a rectangular profile and has, on one of its surfaces, at least two cylindrical projections with the same profile as the projections of the modules, said projections being adapted to allow the connection of the module, or a set of modules previously assembled together, to said fastener, the latter having at least two holes adapted to allow the passage of screws, hooks and similar systems, for fastening on a wall, said fastener further having at least one recess, preferably at least two recesses, along the edge of one of the longer sides of its rectangular profile, said recesses each defining the hole, each hole having variable width due to the mating system slidable inside said recess, said system being made of the same material constituting said fastener, the latter also having at least two projecting tabs, said tabs being extended orthogonal to the rectangular plane of the fastener, said systems and said tabs being adapted to generate a grip of variable width for the edge of a common rigid panel.

6. The kit of information media according to claim 1 wherein it comprises the module(s) having a length of the sides comprised between 10 cm and 40 cm and a thickness comprised between 4 mm and 12 mm; the pocket(s) having the front surface having a width comprised between 10 cm and 15 cm, the rear surface having a width comprised between 10 cm and 15 cm, the side surfaces having a width comprised between 15 mm and 25 mm; the hinge(s) with rectangular profile having the sides with a width comprised between 4 mm and 8 mm; the clip having a width comprised between 20 mm and 40 mm, a height comprised between 55 mm and 70 mm and a thickness comprised between 10 mm and 18 mm calculated taking into account the height of the tabs.

7. The kit of information media according to claim 1, wherein it comprises the module(s) having a width of the sides comprised between 15 cm and 30 cm, preferably said modules having lengths of the sides 15×30 and/or 15×15 and/or 30×30, and said modules having a thickness of; the pockets having the front surface of 12.4 cm of width and 10.5 cm of height, the rear surface of 12.4 cm of width and of 10.5 cm of height, the side surfaces having a width of 23.01 mm and a height of 14.9 cm; the hinges, with rectangular profile, having the shorter sides of 2.045 cm of length and the longer sides of 3.90 cm of length; the clips having a width of 39.41 mm, a height of 63.03 mm and a thickness of 21.96 mm, measured taking into account the height of the projection; the fastener(s), with rectangular profile, having the shorter sides of 3.625 cm of length, the longer sides of 24.149 cm of length and the thickness of 18 mm, measured taking into account the height of the tabs.

8. The kit of information media according to claim 1, wherein all the components thereof are made of polymeric material.

9. The kit of information media according to claim 1 wherein it is made of PC and/or PMMA.

10. The use of the kit of information media according to claim 1 in tobacconists, betting agencies and the like.
